(19) United States
(12) Patent Application Publication
(10) Pub. No.: US 2004/0052519 A1
(43) Pub. Date: Mar. 18, 2004

(54) Protected linear optical network

(76) Inventor: Ross Halgren, Collaroy Plateau (AU)

Correspondence Address: CHRISTIE, PARKER & HALE, LLP, 350 WEST COLORADO BOULEVARD, SUITE 500, PASADENA, CA, 91105, US

(21) Appl. No.: 10/014,875

(22) Filed: Dec. 11, 2001

(51) Int. Cl. H04B 10/08; H04B 10/20; H04J 14/00

(52) U.S. Cl. 398/5

(57) ABSTRACT

A linear or bus optical network comprising first and second end nodes and a plurality of primary nodes disposed, in use, between the end nodes, wherein each end node is connected to its nearest neighbouring primary node and its 2nd nearest neighbouring primary node, and wherein each primary node is connected to its 2^{nd} nearest neighbouring primary or end node on either side, or, where one of its nearest neighbouring nodes is one of the end nodes, to said one end node and to its 2^{nd} nearest neighbouring primary or end node on the other side.

### FIELD OF THE INVENTION

The present invention relates broadly to a linear or bus optical network, and to a method of conducting transmission in a linear or bus optical network.

The present invention will be described herein with reference to a wavelength division multiplexing (WDM) linear optical network. However, it will be appreciated that the present invention does have broader applications, including to any optical linear network using an transmission technology for providing bi-directional transmission, such as e.g. synchronous optical networks (SONET) or synchronous digital hierarchy (SDH).

### BACKGROUND OF THE INVENTION

Linear or bus optical networks comprise a linear link of network nodes. Due to the linear nature of such networks, as opposed to e.g. ring-networks, a return or redundant transmission path is not typically provided. Although a return path could be provided via another fibre in the same cable and conduit as the outward path, this is often impossible because the return transmission distance, which extends the entire length of the linear network, is typically too long, i.e. the return path is beyond link limits for e.g. un-amplified optical connections. Accordingly, such linear optical networks are un-protected in terms of optical fibre break or cable break (i.e. break of all fibres contained in one physical cable, e.g. a standard pair of fibres), or failure of a network node.

The present invention seeks to provide a linear optical network in which protection for failure of a node or a fibre break can be provided.

### SUMMARY OF THE INVENTION

In accordance with a first aspect of the present invention there is provided a linear or bus optical network comprising first and second end nodes and a plurality of primary nodes disposed, in use, between the end nodes, wherein each end node is connected to its nearest neighbouring primary node and its 2nd nearest neighbouring primary node, and wherein each primary node is connected to its 2^{nd} nearest neighbouring primary or end node on either side, or, where one of its nearest neighbouring nodes is one of the end nodes, to said one end node and to its 2^{nd} nearest neighbouring primary or end node on the other side.

Preferably, the optical connection between neighbouring nodes is effected through a pair of optical fibres, wherein each fibre of the pair is arranged, in use, to carry bi-directional transmission, and wherein each primary node is connected to only one fibre of the pair on each side, whereby the primary nodes are alternately connected via single fibre connections, and wherein each end node is connected to both fibres of the pair.

In another embodiment, the optical connection between neighbouring nodes is effected through at least two pairs of optical fibres, wherein each fibre of the pairs is arranged, in use, to carry uni-directional transmission, with the transmission directions of the two fibres of each pair being opposite to each other, and wherein each primary node is connected to one of the pairs on each side, whereby the primary nodes are alternately connected via a pair of uni-directional fibres for bi-directional transmission, and wherein each end node is connected to both fibre pairs.

The network may further comprise one or more secondary nodes, where each secondary node is connected in-line between two connected ones of the end or primary nodes.

Advantageously, each of the nodes is arranged, in use, to regenerate the transmission signal.

The network may be arranged as a WDM network, a SONET network, or a SDH network.

One of the end nodes may be connected to a core or metro optical network. The core or metro optical network may be a protected optical ring-network.

In accordance with a second aspect of the present invention there is provided a method of conducting transmission in a linear or bus optical network comprising two end nodes and a plurality of primary nodes disposed between the end nodes, the method comprising the steps of transmitting from each end node to its nearest neighbouring primary node and to its 2nd nearest neighbouring primary node, and transmitting from each primary node to its 2^{nd} nearest neighbouring primary or end node on either side, or, where one of its nearest neighbouring nodes is one of the end nodes, to said one end node and to its 2^{nd} nearest neighbouring primary or end node on the other side.

Preferably, the transmitting between neighbouring nodes is effected utilising a pair of optical fibres, wherein each fibre of the pair carries bi-directional transmission, and wherein each primary node is connected to only one fibre of the pair on each side, whereby the intermediate nodes are alternately connected via single fibre connections, and wherein each end node is connected to both fibres of the pair.

In another embodiment, the transmitting between neighbouring nodes is effected utilising at least two pairs of optical fibres, wherein each fibre of the pairs carries unidirectional transmission, with the transmission direction of the two fibres of each pair being opposite to each other, and wherein each primary node is connected to one of the pairs on each side, whereby the primary nodes are alternately connected via a pair of uni-directional fibres for bi-directional transmission, and wherein each end node is connected to both fibre pairs.

Advantageously, the method further comprises the step of regenerating the transmission signal at each node.

The step of transmitting between two connected ones of the end or primary nodes may comprise transmitting via one or more secondary nodes connected in-line between said two connected nodes.

### BRIEF DESCRIPTION OF THE DRAWINGS

Preferred embodiments of the present invention will now be described, by way of example only, with reference to the accompanying drawings.

FIG. 1 is a schematic drawing illustrating an un-protected linear network;

FIG. 2 is a schematic drawing illustrating a hardware-protected linear network embodying the present invention.

FIG. 3 is a schematic drawing illustrating another hardware-protected linear network embodying the present invention.

FIG. 4 is a schematic drawing illustrating an extended version of the linear network of FIG. 3.

FIG. 5 is a schematic drawing of a network node structure for use in a protected linear optical network embodying the present invention.

FIG. 6 is a schematic drawing of a detail of FIG. 4.

### DETAILED DESCRIPTION OF THE EMBODIMENTS

The preferred embodiments described provide a linear optical network with protection for failure of a network node or a fibre break.

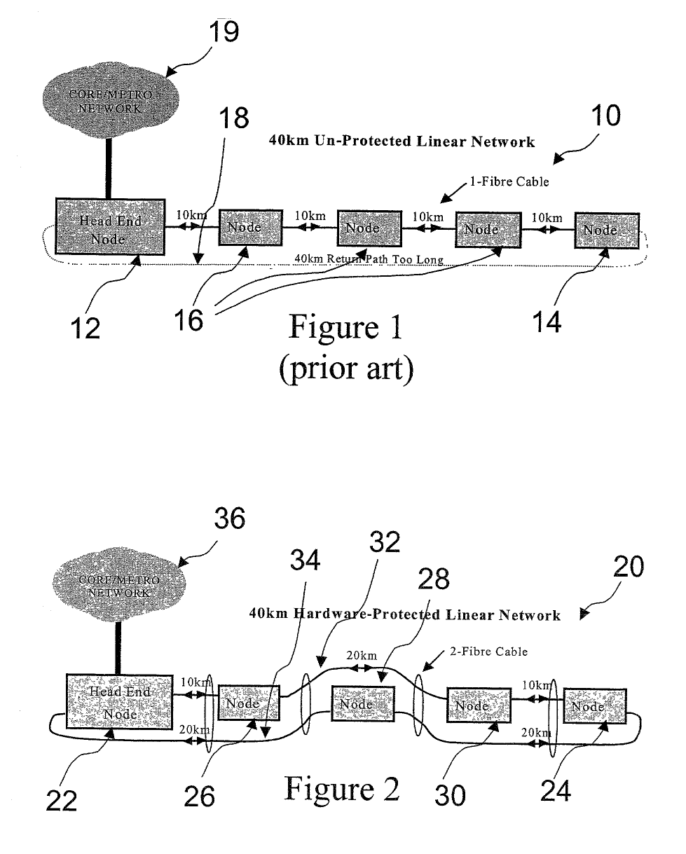

FIG. 1 shows a conventional linear network 10 comprising two end nodes, 12, 14 and a plurality of in-line nodes 16. One of the end nodes 12 is connected to a core/metro network ring network 19. The linear network 10 could be protected by the provision of a return path 18 between the end nodes 12, 14, to effectively complete a logical ring connection between the various nodes of the optical network 10. However, since the return path 18 extends the entire “length” of the linear network 10, the transmission distance in the return path 18 will typically be beyond link limits realisable in such linear networks. In the example linear network 10 shown in FIG. 1, a maximum transmission distance between nodes may be 20 km, thus the 40 km return path 18 is beyond the link limits and thus unrealisable.

Turning now to FIG. 2, in an optical linear network 20 embodying the present invention, there are again provided two end nodes 22, 24 and a plurality of intermediate nodes 26, 28, 30. One of the end nodes 22 is connected to a core/metro network ring network 36.

The end nodes 22, 24 connect to both their nearest neighbour and second nearest neighbour, i.e. end node 22 is connected to intermediate node 26 and intermediate node 28, whereas end node 24 is connected to intermediate node 30 and intermediate node 28.

The intermediate node 26 is connected to the end node 22 on one side, and to the second nearest neighbour on the other side, i.e. to intermediate node 30. Similarly, the intermediate node 30 is connected to end node 24 on one side, and the second nearest neighbour on the other side, i.e. intermediate node 26.

Intermediate node 28 is connected to its second nearest neighbours on both sides, i.e. to end nodes 22 and 24.

It will be appreciated by a person skilled in the art that accordingly each of the intermediate nodes 26, 28, 30 is alternately connected on the bi-directional “outward” path 32, and the bi-directional return path 34. In other words, while the maximum transmission distance between two nodes has effectively been increased by a factor of 2 to 20 kms, the transmission length of the return path 34 has been halved when compared with the linear network described above with reference to FIG. 1. Accordingly, this embodiment is well suited for optical networks for which the distance between nodes is less than half the possible transmission distance, but for which the total transmission distance of the linear network is above the possible transmission distance and so a direct return path is not realisable.

The protected linear network 20 can be thought of as a logical ring network within a physical linear cable containing a pair of fibres. In the case of the failure of any node or fibre between two nodes, then the nodes can protect as if they were on a ring network. In the example embodiment shown in FIG. 2, the optical linear network 20 is configured as a duplex 10 Gb/s capacity network on each single fibre, for which four 2.5 Gb/s course WDM (CWDM) channels propagating in each direction on the single fibre (i.e. 8 wavelength total) provide the 10 Gb/s duplex capacity. However, it will be appreciated that the invention is equally suitable for any linear network using any transmission technology regardless of the number of fibres required for bi-directional transmission. For example, for a standard SONET linear link which requires two fibres between nodes, the invention can be implemented using 4 fibres or 2 fibre pairs between nodes.

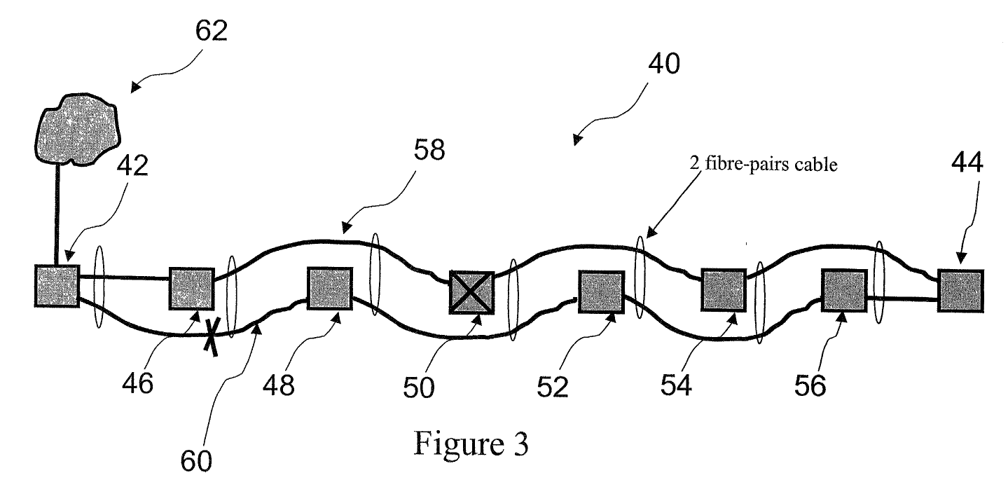

Turning now to FIG. 3, there is shown another protected linear network 40 embodying the present invention. The optical network 40 comprises two end nodes 42, 44, and a plurality of intermediate nodes 46, 48, 50, 52, 54 and 56. One of the end nodes 42 is connected to a core/metro network ring network 62.

In the optical network 40, each end node 42, 44 is connected to its nearest neighbouring intermediate node and its second nearest neighbouring intermediate node. Accordingly, end node 42 is connected to intermediate nodes 46 and 48, whereas end node 44 is connected to intermediate nodes 54, and 56.

On the other hand, each of the intermediate nodes 46, 48, 50, 52, 54 and 56 is either connected to its second nearest neighbouring nodes on either side, or, where one of its nearest neighbouring node is one of the end nodes 42, 44, to that end node and to its second nearest neighbouring node on the other side.

Accordingly, the interconnection of the intermediate nodes 46, 48, 50, 52, 54 and 56 is as follows:

Intermediate node 46, connected to: end node 42 and intermediate node 50.

Intermediate node 48, connected to: end node 42 and intermediate node 52.

Intermediate node 50, connected to: intermediate node 46 and intermediate node 54.

Intermediate node 52, connected to: intermediate node 48, and intermediate node 56.

Intermediate node 54, connected to: intermediate node 50, and end node 44.

Intermediate node 56, connected to: intermediate node 52, and end node 44.

In the example protected linear network 40, the optical connections between nodes are effected through two pairs of optical fibres 58, 60, wherein each fibre of pairs 58, 60 carries unidirectional transmission, with the transmission directions of the two fibres of each pair 58, 60 being opposite to each other for bi-directional transmission. Each intermediate node 46, 48, 50, 52, 54 and 56 is connected to one of the pairs 58, 60 on each side, whereby the intermediate nodes 46, 48, 50, 52, 54 and 56 are alternately connected via a pair of uni-directional fibres for bi-directional transmission. On the other hand, both end nodes, 42, 44 are connected to both fibre pairs, 58, 60, to complete the protection path.

In case of a fibre break in one or both fibres of the pair 60 as indicated by the cross between end node 42 and intermediate node 48 in FIG. 3, transmission between the end node 42 and the intermediate node 48 is switched to the alternative path, i.e. via nodes 52, 56, 44, 54, 50, and 46.

Furthermore, in case of a network node failure, e.g. at network node 50 as indicated by the cross, transmission between node 54 and node 46 is switched from the “direct” path, via the (faulty) node 50, to the protection path via end node 44, node 56, 52, 48, end node 42, and to node 46.

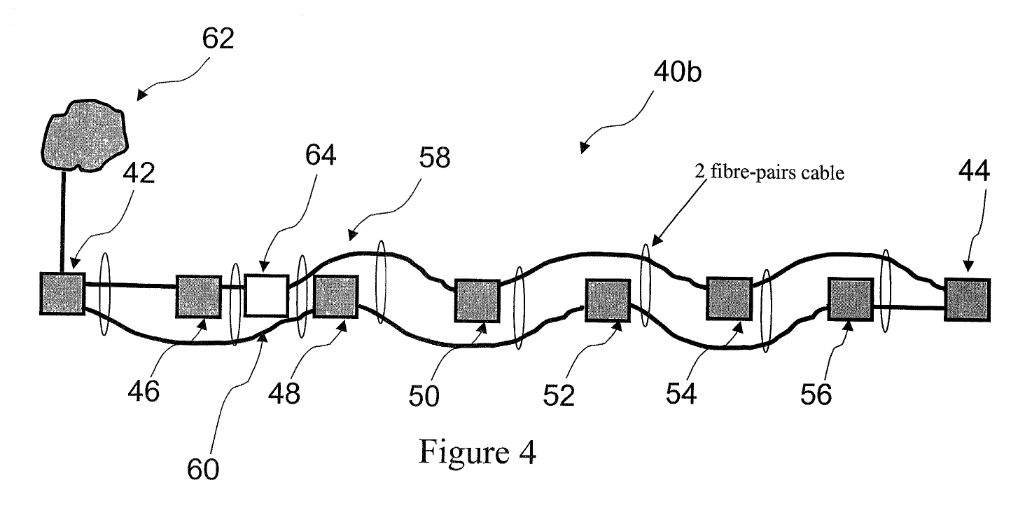

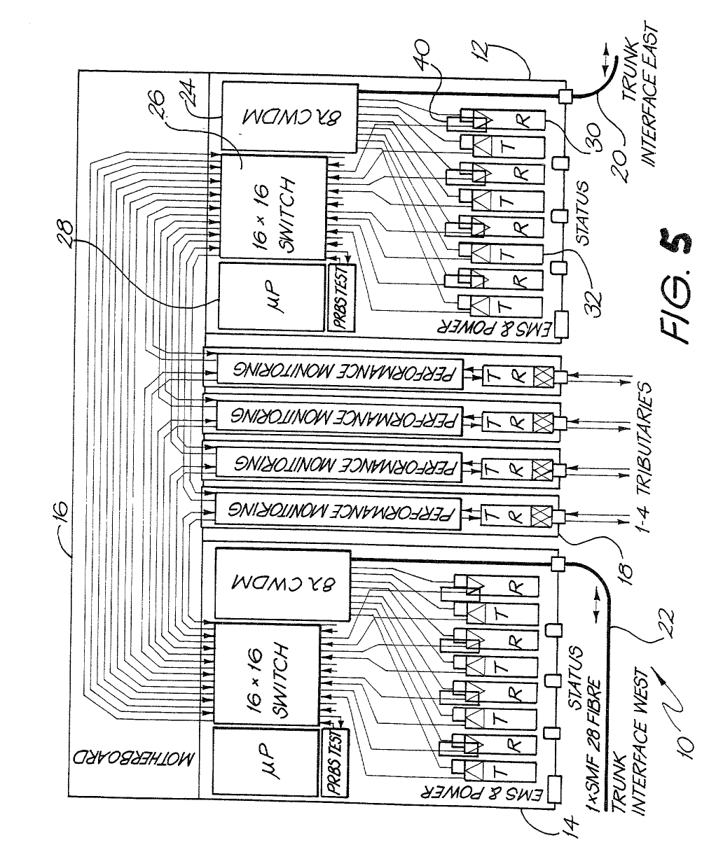

A possible extension of the linear protected optical network 40 shown in FIG. 3 will now be described with reference to FIG. 4. In FIG. 4, the extended linear protected optical network 40b comprises an additional network node 64 located in-line on the fibre-pair 58 between node 46 and node 50.

Importantly, during adding of the additional node 64, which involves breaking the fibre-pair connection 58 between nodes 46 and 50, the linear network 40b remains operable because of its protected nature. In other words, similar to the fibre break scenario described above with reference to FIG. 3, any traffic on the fibre pair connection 58 between nodes 46 and 50 will be diverted to the alternative transmission path.

It is noted that the addition of the node 64 between nodes 46 and 50 (and, indeed, further nodes if desired) does not impose new maximum transmission link restrictions, as it involves only portions of the original transmission link between nodes 46 and 50, which are equal to or below the relevant maximum link length.

Another way of looking at the extended linear network 40b is, that it contains a plurality of primary and end nodes 44, 46, 48, 50, 52, 54 and 56, all of which are in one embodiment characterised by the feature that the distances between second neighbouring end or primary nodes is of the order of the relevant maximum link length. The extended portion consists of a secondary node in the form of node 64 in the example embodiment shown in FIG. 4, and which is characterised in transmission links to the two primary nodes 46, 50, to which it is connected in-line, that are shorter than the relevant maximum link length.

Furthermore, it will be appreciated by the person skilled in the art that the addition of node 64 does not interfere with the protected nature of the linear network 40b, as it occurs “in-line” with the effective ring connectivity of the original protected linear network 40 (see FIG. 3) embodying the present invention.

FIG. 5 shows a schematic diagram of a network node structure 100 for use in protected linear WDM networks embodying the present invention. The node structure 100 comprises two network interface modules 112, 114, an electrical connection motherboard 116 and a plurality of tributary interface modules e.g. 118.

The network interface modules 112, 114 are connected to an optical network east trunk 120 and an optical network west trunk 122 respectively, of a protected linear optical network (not shown) to which the network node structure 110 is connected in-line.

Each of the network interface modules 112, 114 comprises the following components:

a passive CWDM component 124, in the exemplary embodiment a 8 wavelength component;

an electrical switch component, in the exemplary embodiment a 16×16 switch 126;

a microprocessor 128;

a plurality of receiver trunk interface cards e.g. 130; and

a plurality of transmitter trunk interface cards e.g. 132, and

a plurality of electrical regeneration unit e.g. 140 associated with each receiver trunk interface card e.g. 130.

Each regeneration unit e.g. 140 performs 3R regeneration on the electrical channels signal converted from a corresponding optical WDM channel signal received at the respective receiver trunk interface card e.g. 130. Accordingly, the network node structure 100 can provide signal regeneration capability for each channel signal combined with an electrical switching capability for add/drop functionality, i.e. avoiding high optical losses incurred in optical add/drop multiplexers (OADMs).

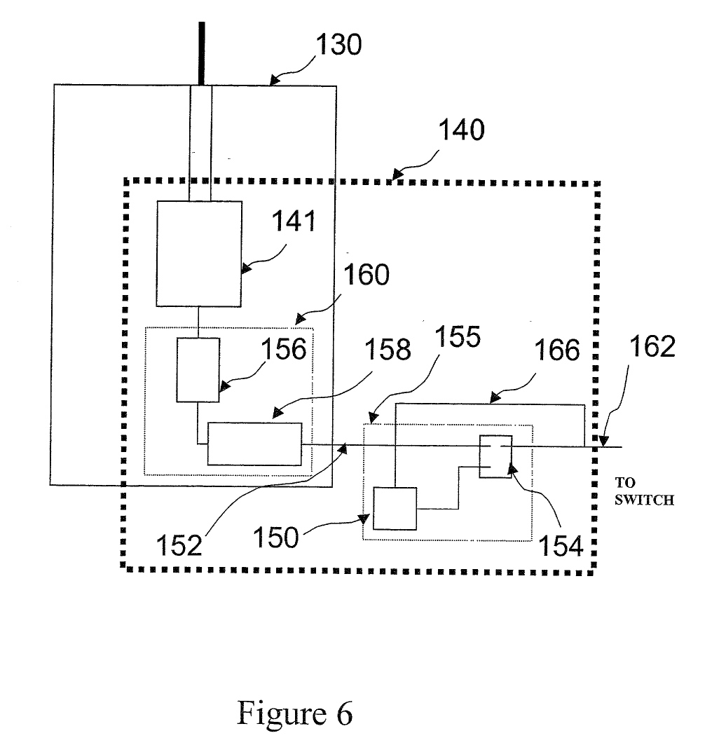

Details of the receiver trunk interface cards e.g. 130 and regeneration unit e.g. 140 of the exemplary embodiment will now be described with reference to FIG. 6.

In FIG. 6, the regeneration component 140 comprises a linear optical receiver 141 of the receiver trunk interface card 130. The linear optical receiver 141 comprises a transimpendence amplifier (not shown) i.e. IR regeneration is performed on the electrical receiver signal within the linear optical receiver 141.

The regeneration unit 140 further comprises an AC coupler 156 and a binary detector component 158 formed on the receiver trunk interface card 130. Together the AC coupler 156 and the binary detector 158 form a 2R regeneration section 160 of the regeneration unit 140.

The regeneration unit 140 further comprises a programmable phase lock loop (PLL) 150 tapped to an electrical input line 152 and connected to a flip flop 154. The programmable PLL 150 and the flip flop 154 form a programmable clock data recovery (CDR) section 155 of the regeneration unit 140.

It will be appreciated by a person skilled in the art that at the output 162 of the programmable CDR section 155 the electrical receiver signal (converted from the received optical CWDM channel signal over optical fibre input 164) is thus 3R regenerated. It is noted that in the example shown in FIG. 5, a 2R bypass connection 166 is provided, to bypass the programmable CDR section 155 if desired.

Returning now to FIG. 5, each of the tributary interface modules e.g. 118 comprises a tributary transceiver interface card 134 and an electrical performance monitoring unit 136. A 3R regeneration unit (not shown) similar to the one described in relation to the receiver trunk interface cards e.g. 130 with reference to FIG. 6 is provided. Accordingly, 3R regeneration is conducted on each received electrical signal converted from received optical input signals prior to the 16×16 switch 126.

As can be seen from the connectivity provided through the electrical motherboard 116, each of the electrical switches 126 facilitates that any trunk interface card e.g. 130, 132 or tributary interface card e.g. 118 can be connected to any one or more trunk interface card e.g. 130, 132, or tributary interface card e.g. 118. Accordingly, e.g. each wavelength channel signal received at the western network interface module 114, e.g. at receiver trunk interface card 138 can be dropped at the network node associated with the network node structure 100 via any one of the tributary interface modules e.g. 118, and/or can be through connected into the optical network trunk east 120 via the east network interface module 112.

Furthermore, it will also be appreciated by the person skilled in the art that the network node structure 100 is west-east/east-west traffic transparent. Also, due to the utilisation of network interface modules 112, 114 which each incorporate a 16×16 switch 126, a redundant switch is readily provided for the purpose of protecting the tributary interface cards e.g. 118 from a single point of failure. The tributary interface cards e.g. 118 are capable of selecting to transmit a signal to either (or both) network interface modules 112, 114 and the associated switches e.g 126. The function of the switches e.g. 126 is to select the wavelength and direction that the optical signal received from the tributary interface cards e.g. 118 will be transmitted on and into the optical network.

One of the advantages of the network structure 100 (FIG. 5) is that the electronic switches support broadcast and multicast transmissions of the same signal over multiple wavelengths. This can have useful applications in entertainment video or data casting implementation. Many optical add/drop solutions do not support this feature, instead, they only support logical point-point connections since the signal is dropped at the destination node and does not continue to the next node.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. A linear or bus optical network comprising:
first and second end nodes and
a plurality of primary nodes disposed, in use, between the end nodes,
wherein each end node is connected to its nearest neighbouring primary node and its 2nd nearest neighbouring primary node, and
wherein each primary node is connected to its 2^{nd} nearest neighbouring primary or end node on either side, or, where one of its nearest neighbouring nodes is one of the end nodes, to said one end node and to its 2^{nd} nearest neighbouring primary or end node on the other side.

2. A network as claimed in claim 1, wherein the optical connection between neighbouring nodes is effected through a pair of optical fibres, and
wherein each fibre of the pair is arranged, in use, to carry bi-directional transmission, and
wherein each primary node is connected to only one fibre of the pair on each side, whereby the primary nodes are alternately connected via single fibre connections, and
wherein each end node is connected to both fibres of the pair.

3. A network as claimed in claim 1, wherein the optical connection between neighbouring nodes is effected through at least two pairs of optical fibres, and
wherein each fibre of the pairs is arranged, in use, to carry unidirectional transmission, with the transmission directions of the two fibres of each pair being opposite to each other, and
wherein each primary node is connected to one of the pairs on each side, whereby the primary nodes are alternately connected via a pair of unidirectional fibres for bi-directional transmission, and
wherein each end node is connected to both fibre pairs.

4. A network as claimed in any one of the preceding claims, wherein the network further comprises one or more secondary nodes, wherein each secondary node is connected inline between two connected ones of the end or primary nodes.

5. A network as claimed in claim 1, wherein each of the nodes is arranged, in use, to regenerate the transmission signal.

6. A network as claimed in claim 1, wherein the network is arranged as a WDM network.

7. A network as claimed in claim 1, wherein the network is arranged as a SONET or SDH network.

8. A network as claimed in claim 1, wherein one of the end nodes is connected to a core or metro optical network.

9. A network as claimed in claim 8, wherein the core or metro optical network is a protected optical ring-network.

10. A method of conducting transmission in a linear or bus optical network comprising two end nodes and a plurality of primary nodes disposed between the end nodes, the method comprising the steps of:
transmitting from each end node to its nearest neighbouring primary node and to its 2nd nearest neighbouring primary node, and
transmitting from each primary node to its 2^{nd} nearest neighbouring primary or end node on either side, or, where one of its nearest neighbouring nodes is one of the end nodes, to said one end node and to its 2^{nd} nearest neighbouring primary or end node on the other side.

11. A method as claimed in claim 10, wherein the transmitting between neighbouring nodes is effected utilising pair of optical fibres, and
wherein each fibre of the pair carries bi-directional transmission, and
wherein each intermediate node is connected to only one fibre of the pair on each side, whereby the intermediate nodes are alternately connected via single fibre connections, and
wherein each end node is connected to both fibres of the pair.

12. A method as claimed in claim 10, wherein the transmitting between neighbouring nodes is effected utilising at least two pairs of optical fibres, and
wherein each fibre of the pairs carries uni-directional transmission, with the transmission direction of the two fibres of each pair being opposite to each other, and
wherein each primary node is connected to one of the pairs on each side, whereby the primary nodes are alternately connected via a pair of uni-directional fibres for bi-directional transmission, and
wherein each end node is connected to both fibre pairs.

13. A method as claimed in any one of claims 10 to 12, wherein the step of transmitting between two connected ones of the end or primary nodes comprises transmitting where one or more secondary nodes connected in-line between said to connected nodes.

14. A method as claimed in claim 10, wherein the method further comprises the step of regenerating the transmission signal at each node.
